(19) United States
(12) Patent Application Publication
(10) Pub. No.: US 2003/0182863 A1
(43) Pub. Date: Oct. 2, 2003

(54) Control system for a vehicle door latch

(76) Inventors: Veronique Mejean, Saint Die (FR); Marc Madeddu, Saint-Leonard (FR)

Correspondence Address: CARLSON, GASKEY & OLDS, P.C., 400 WEST MAPLE ROAD, SUITE 350, BIRMINGHAM, MI, 48009, US

(21) Appl. No.: 10/405,911

(22) Filed: Apr. 2, 2003

(30) Foreign Application Priority Data
Apr. 2, 2002 (GB) 0207526.5

(51) Int. Cl. E05F 15/02

(52) U.S. Cl. 49/26

(57) ABSTRACT

A vehicle door latch control system detects latch malfunctions via a closed loop system that includes a first switch that is triggered by operation of a door handle and a second switch that indicates whether a latch is in a fully latched position. A controller monitors the operating states of the first and second switches and interprets these operating states to determine door and latch operation as well as detect a latch malfunction.

### REFERENCE TO RELATED APPLICATIONS

The present invention claims priority to United Kingdom (GB) patent application number 0207526.5, filed Apr. 2, 2002.

### TECHNICAL FIELD

The present invention relates to a control system for a vehicle door latch and more particularly, relates to a closed loop latch control system.

### BACKGROUND OF THE INVENTION

Currently known electronic control systems for vehicle door latches provide latch control, but are unable to provide diagnostic fault or malfunction detection. In the present application, the term “malfunction” refers to a specific fault or an anticipated fault with a latch component, such as a non-functioning motor or a seized lever, or a blockage of a latch component due to an incorrect position of another latch component (e.g. if a latch has been instructed to carry out an operation sequence too rapidly for a motor to complete one operation before starting another operation).

In practical terms, currently known control systems include, for example, a controller that instructs a power actuator to change a particular state of a latch component. If the actuator is unable to change the latch component's state (e.g., if the actuator is obstructed or has failed) due to an event that is not rectifiable during normal use, the controller currently has no way of notifying the user that the latch component has failed to change state. Instead, the actuator can only repeatedly signal the latch component to carry out the state change even though the latch component is incapable of doing so.

In other instances, the controller may assume that user intervention, rather than a latch malfunction, is the cause of latch operation failure. For example, a user may try to lock all latches in a vehicle via a power door lock, but one of the latches may fail to lock. The latch control system may then interpret this failure as a request by the user to unlock all of the latches, including the latches that were successfully locked. The vehicle user may be unaware of this fault, resulting in possible compromise of vehicle security or safety, and/or damage of the latch.

Further, the controller may receive instructions that are outside the operating parameters or physical limitations of the latch component. When the latch component attempts to carry out the instructions from the controller, a malfunction may occur due to, for example, an incorrectly timed sequence of operations being performed within the latch.

There is a need for a vehicle door latch system that can diagnose faults and detect malfunctions within the system.

### SUMMARY OF THE INVENTION

One embodiment of the present invention is directed to a closed loop vehicle door latch control system comprising a controller, a latch including at least one sensor and at least one power actuator. The closed loop structure of the system allows detection of a latch malfunction causing latch failure. Further, the closed loop system can also detect a latch malfunction that causes the latch to fail in carrying out an instruction from the controller. In either case, the system is configured to generate an error signal when the latch malfunction is detected.

The invention is also directed to a method of controlling a closed loop control system having a controller and a vehicle door latch including at least one sensor and at least one power actuator. In one embodiment, the method includes the steps of: i) interpreting an input from a vehicle user and instructing the latch to perform a predetermined operation on the basis of the instruction; ii) detecting whether the latch has performed the operation or has malfunctioned; iii) generating an error signal if a malfunction has been detected.

The invention is also directed to a closed loop control system for a vehicle door latch. The closed loop control system comprises a controller, a latch including at least one sensor and at least one power actuator. The system is able to detect when the latch has failed or will fail to carry out an instruction from the controller due to a latch malfunction and is configured to attempt to prevent or overcome the malfunction.

Yet another aspect of the invention is directed to a method of controlling a closed loop control system having a controller and a vehicle door latch including at least one sensor and at least one power actuator. The method comprises interpreting an input from a vehicle user and instructing the latch to perform a predetermined operation on the basis of the instruction, detecting whether the latch has performed the operation or has malfunctioned, and attempting to overcome the malfunction if a malfunction is detected.

A further aspect of the present invention is directed to a method of controlling a closed loop control system comprising a controller and a vehicle door latch including at least one sensor and at least one power actuator. The method comprises the steps of interpreting an input from a vehicle user to perform an operation, determining whether the latch is capable of performing the operation or whether carrying out the operation will cause a malfunction, and attempting to prevent the malfunction when instructing the latch to perform the operation.

### BRIEF DESCRIPTION OF THE DRAWINGS

FIG. 1 is a schematic diagram of a latch incorporating a control system according to one embodiment of the present invention;

FIG. 2 is a table illustrating functions of the control system of FIG. 1;

FIG. 3 is a diagram illustrating a normal function of the control system of FIG. 1;

FIG. 4 is a diagram illustrating the function of the control system of FIG. 1 during a malfunction;

FIG. 5 is a further diagram illustrating the function of the control system of FIG. 1;

FIG. 6 is a diagram illustrating a normal function of a control system according to another embodiment of the present invention;

FIG. 7 is a diagram illustrating a potentially malfunctioning state of the latch of FIG. 1 in the absence of the inventive control system; and

FIG. 8 is a diagram illustrating operation of the latch of FIG. 1 with a control system according to one embodiment of the present invention.

### DETAILED DESCRIPTION OF THE EMBODIMENTS

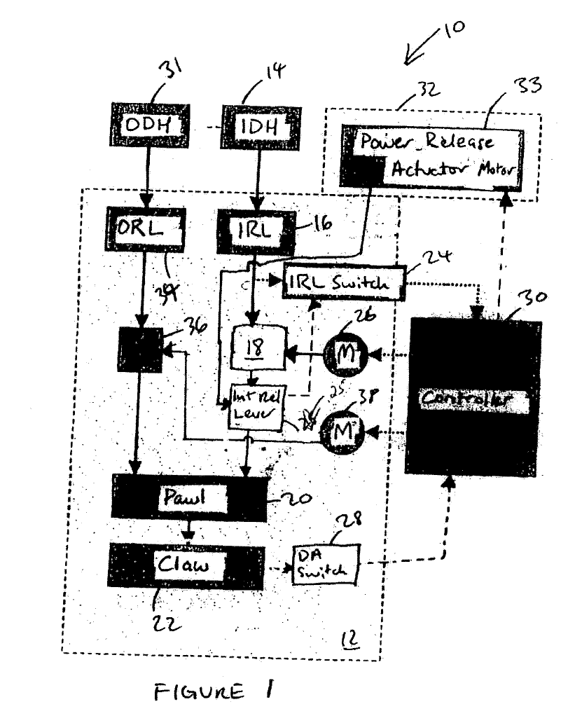

FIG. 1 is a schematic illustrating a control system 10 for a vehicle door latch 12 according to one embodiment of the invention. In FIG. 1, mechanical connections are illustrated by arrows with solid lines and electrical connections are illustrated by arrows with broken lines. An inside door handle (IDH) 14 fitted to an interior face of a vehicle door (not shown) is operably connected to the inside release lever (IRL) 16 of the latch by a mechanical connection such as a cable or rod. The inside release lever is coupled to an intermediate release lever 25 via a first locking mechanism 18. In turn, the intermediate release lever 25 is coupled to a pawl 20 arranged to releasably retain a latch bolt in the form of a rotatable claw 22. The rotatable claw 22 is provided with pawl abutments (not shown) corresponding to a first safety position and a fully latched position of the claw 22 when the abutments are engaged by the pawl 20.

To selectively provide a block or break in the transmission path from the inside door handle 14 to the pawl 20 at the first locking mechanism 18 for locking purposes, a power actuator, such as an inside motor 38 is provided. Additionally, the latch 12 may be locked manually by a known locking device, such as a conventional key. A controller 30 in the system provides instructions, such as electrical signals, instructing the motor 26 to change the state of the first locking mechanism 18 between a locked and unlocked state. In one embodiment, the controller 30 is located remotely from the latch 12. The controller 30 is preferably in the form of a micro-processor and may, in other embodiments, be integrated into the latch 12.

An outside door handle 31 mounted on an outer face of the vehicle door is operably connected to an outside release lever 34, which is in turn operably connected to the pawl 20 through a second locking mechanism 36. A block or break may be provided in the transmission path by a outside motor 38 through the second locking mechanism 36, with this block or break representing the mechanism 36 being locked from the outside. In this case, the outside motor 38 is also controlled by the controller 30.

In this embodiment, the latch 12 is provided with two sensors. The first sensor is an inside release lever (IRL) switch 24 that signals the controller 30 when the inside door handle 14, and hence the inside release lever 16, are being actuated by a vehicle user. The IRL switch 24 also signals the controller 30 when the intermediate release lever 25 is actuated independently of the inside release lever 16. The second sensor is a door ajar (DA) switch 28, which is associated with the claw 22 and signals the controller 30 when the claw 22 has been released from its fully latched position. In one embodiment, the door ajar switch 28 is triggered when the claw 22 has rotated to a position approximately halfway between the fully latched and first safety abutments.

A power release actuator 32 having an actuator motor 33 is also associated with the latch 12. In this description, the term “power actuator” is intended to cover any form of motor powered by a vehicle power source, such as the vehicle battery, and excludes actuators, such as handles, where the power source is manual energy applied by the vehicle user.

When the actuator 32 receives the appropriate signal from the controller 30, the actuator 32 drives the release lever 25 to lift the pawl 20 out of engagement with the claw 22, thereby releasing the latch 12. Under normal circumstances, the latch 12 is released by the power release actuator 32. The mechanical transmission paths from the inside door handle 14 and the outside door handle 31 to the pawl 20 are provided as a back-up release mechanism in case the power to the latch is disconnected due to, for example, an accident or a dead battery.

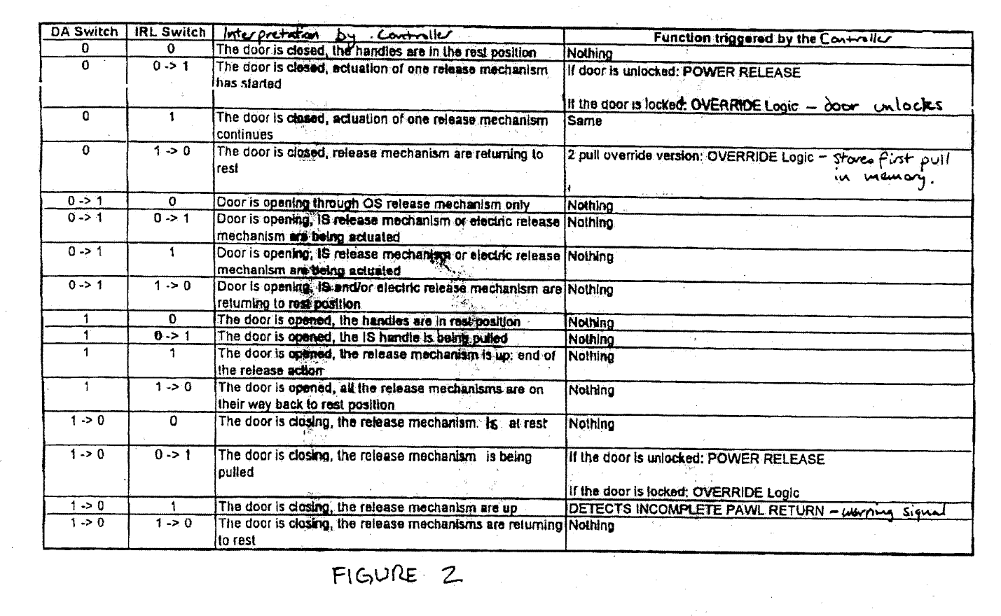

FIG. 2 shows the operation of the latch 12 in response to outputs received from the door ajar switch 28 and the inside release switch 24 according to one embodiment of the invention. As shown in FIG. 2, the logic of the controller 30 can interpret every possible combination of outputs from the door ajar switch 28 and the inside release switch 24 (including output transitions from 0 to 1 and 1 to 0) to correspond to a particular state of the latch 12 and hence the associated door (not shown). Although FIG. 2 and the examples described below focus on components operable by the inside door handle 14, the inventive concepts are equally applicable to components operable by the outside door handle 31.

Where appropriate, the logic of controller 30 may instruct one or more of the first and second motors 26 and 38 and the power release actuator motor 33 to unlock the latch 12 or conduct power release of the latch 12.

It can be seen that in this embodiment, the controller 30 logic has been programmed to provide a two-pull override function for the inside door handle 14. In other words, a first pull of the inside door handle 14 will send a signal from the inside release switch 24 to the controller 30, which in turn instructs the inside and outside motors 26 and 38 to remove the block or break in the inside and outside locking mechanisms 18 and 36. When the inside door handle 14 is released, the controller 30 then stores data indicating that the inside door handle has been pulled once.

If the inside door handle 14 is pulled a second time, the controller 30 determines that the latch 12 should be released and accordingly instructs the power release actuator motor 33 to lift the pawl 20. If the power release operation fails, the latch 12 may be released via the mechanical linkage from the inside and outside door handles 14, 31 to the pawl 20. This may require a greater force to be exerted by a vehicle user on the inside door handle 14 or outside door handle 31 to release the latch 12.

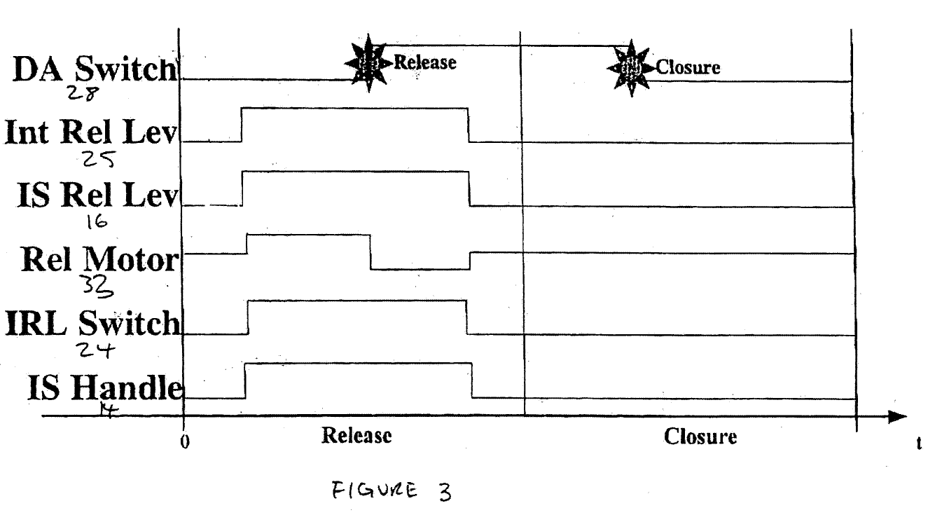

Normal operation of the latch 12 is illustrated by the timing diagram in FIG. 3. The latch 12 starts in a latched and unlocked state. FIG. 3 illustrates the output signal of the door ajar switch 28, the positions of the intermediate release lever 25 and the inside release lever 16, the voltage applied to the power release actuator motor 33, the output signal of the inside release lever switch 24, and the position of the inside handle 14. All of the various switches, motors and levers start in a rest position in this example.

When the inside door handle 14 is pulled, the inside release lever switch 24 emits an output corresponding to the “1” state described in FIG. 2. Because the latch 12 is in an unlocked state at this time, the controller 30 signals the power release actuator motor 33 to act on the pawl 20 to release the claw 22 from the fully latched position. In turn, rotating the claw 22 to a position between the fully latched and first safety positions causes the door ajar switch 28 to signal the controller 30 that the latch 12 has been released. In this embodiment, once the latch release has been detected, the controller 30 signals the power release actuator motor 33 to drive itself back to its normal rest position.

To close the door, the vehicle user simply pushes the door shut. When the door is closed, the claw 22 engages with a corresponding striker (not shown) on the door surround (not shown), causing the claw 22 to rotate back to its latched position. The door ajar switch 28 then indicates that latch closure has been achieved, as shown in FIG. 3.

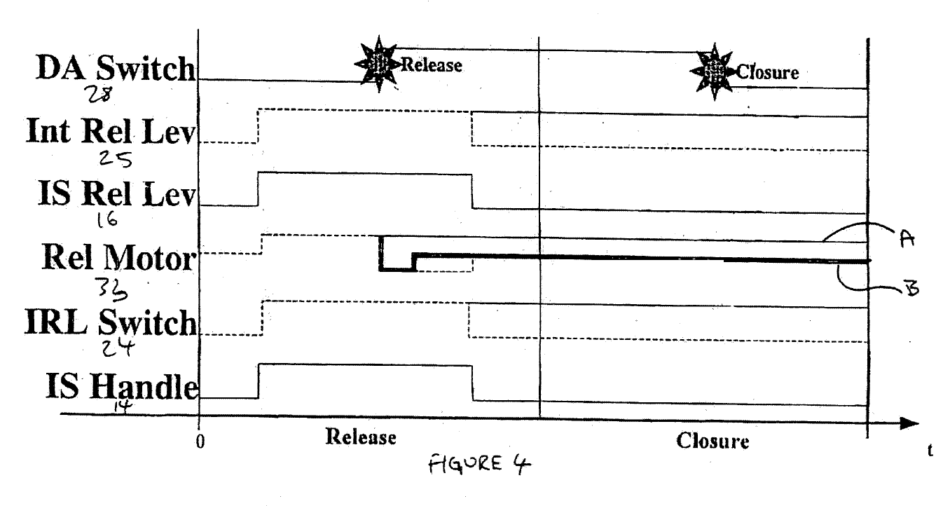

Referring to FIG. 4, the normal latch operation sequence is shown in broken lines and the actual position/state of each component in this example is shown in unbroken lines. As shown in FIG. 4, the intermediate release lever 25 may remain stuck in an actuated state despite the release of the inside door handle 14. This may occur due to jamming of the inside release lever 16 from rust, ice, or dirt ingress or the like or because a malfunction causes the power release actuator motor 33, which drives the intermediate release lever 25, to continue to be powered. Since the intermediate release lever 25 remains actuated in this case, the pawl 20 cannot engage any claw abutment when an attempt is made to latch the latch 12. This means that although the door ajar switch 28 may indicate a latch closure, actual latching will not have successfully occurred in this condition.

The “jammed” condition is illustrated by line B in the release motor impact voltage graph in FIG. 4. In this condition, the power release actuator motor 33 is back-driven, causing a jam. The voltage applied to the power release actuator motor 3 is then dropped to zero by a motor overload prevention device (not shown), as shown in FIG. 4. The motor malfunction condition is illustrated by line A in FIG. 4, which shows a continued voltage being applied to the motor 33. In one embodiment, a dog clutch connection between the intermediate release lever 25 and the inside release levers 16 nevertheless enables the inside release lever to return to its rest position despite the motor malfunction.

A timer is provided in controller 30. Once the controller 30 determines that the inside release switch 24 is continuing to generate a high output after a predetermined time period set by the timer, the controller 30 generates an error code that may be sent to a vehicle diagnostic system and/or a dashboard warning light or a buzzer, for example. Alternatively, an error code may be generated as a result of a continued high output from the inside release switch 24 while the door ajar switch 28 is incorrectly indicating that the latch 12 is closed in its fully latched position. Thus, even though a malfunction prevents correct operation of the latch 12 in this case, the inventive system alerts vehicle users to the malfunction, allowing users to take appropriate steps to rectify it due to the closed loop configuration of the invention.

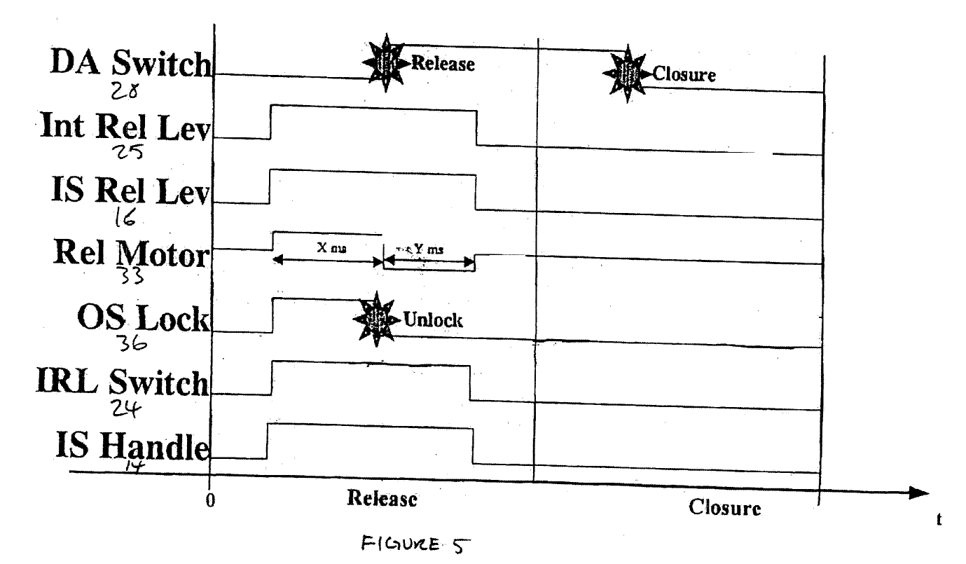

FIG. 5 illustrates another embodiment of the inventive control system operation. In this embodiment, the latch 12 is provided with a single pull override unlocking function. In these circumstances, the user pulls the inside handle 14, triggering activation of the inside release lever 16 and the intermediate release lever 25. This in turn causes the inside release switch 24 to emit a high output. In this case, the controller 30 is programmed to simultaneously signal the outside lock 36 to unlock and to signal the release motor 33 to lift the pawl 20 from the claw 22, thereby releasing the latch 12. As before, once latch release is detected by the door ajar switch 28, the controller 30 instructs the release motor 33 to back-drive to its rest position. Once the intermediate release lever 25 is back in its rest position, the inside lock 18 is unlocked by the inside motor 38. By delaying the unlocking until after latch release has occurred, the release process may occur more quickly. Thereafter, the door may be slammed shut as before, returning to a latched but unlocked state.

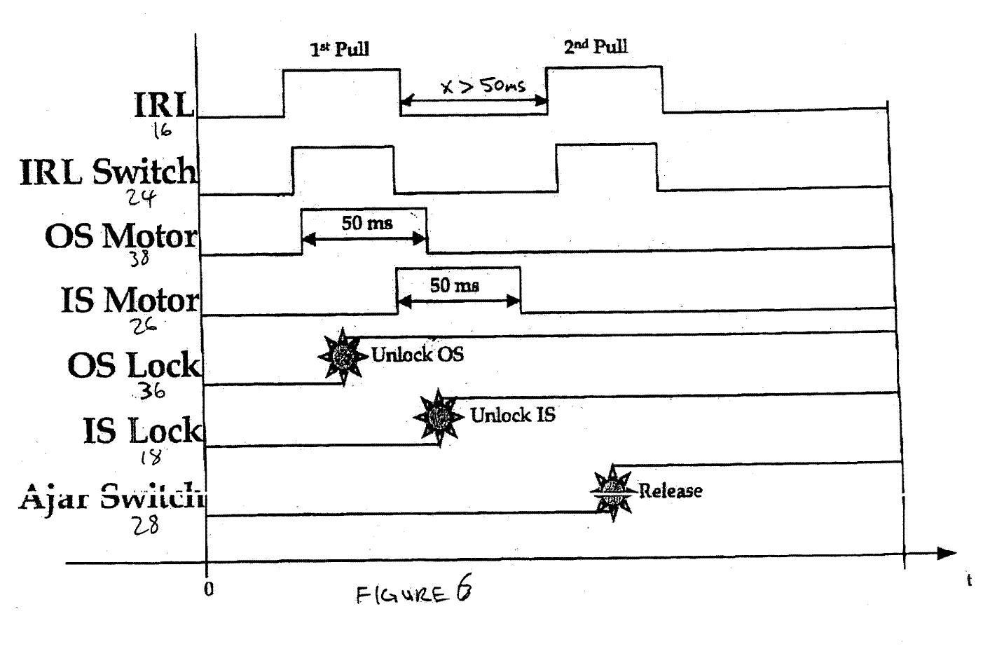

FIG. 6 illustrates another embodiment of the inventive control system operation. This embodiment may complement the control system of the first embodiment described above. In FIG. 6, the latch 12 starts in a locked condition. A first pull of the inside release lever 16 causes the inside release switch 24 to emit a high output. This output is processed by the controller 30; as explained above, the logic in the controller 30 dictates that the first pull of the outside door handle 31 and the inside door handle 14 should signal the outside motor 38 and the inside motor 26 to unlock the outside and inside lock mechanisms 36 and 18, respectively. For unlocking of the inside lock mechanism 36 to occur, the inside release lever 16 must return to its rest position, whereas unlocking of the outside lock mechanism 36 may occur at any time. Thus, both the outside and inside lock mechanisms 36 and 18 change to an unlocked state, with the unlocking of inside unlocking mechanism 18 being slightly delayed.

There then follows a delay x of greater than a selected time period, such as 50 milliseconds, between the first pull of the inside handle 14 and a second pull (as represented by inside release lever 16). This time period x is selected to be sufficient for both the outside and inside motors 38 and 26 to unlock the latch 12. Because the controller 30 has stored the current state of the outside and inside locks 36 and 18 as being unlocked from the first pull, the second pull of the inside door handle 14 causes the controller 30 to signal the power release actuator 32 to release the claw 22. A successful release is detected by the door ajar switch 28 as in the previous embodiment. Alternatively, the power unlatching actuator 32 may be omitted from the latch 12 with unlatching occurring via mechanical transmission paths.

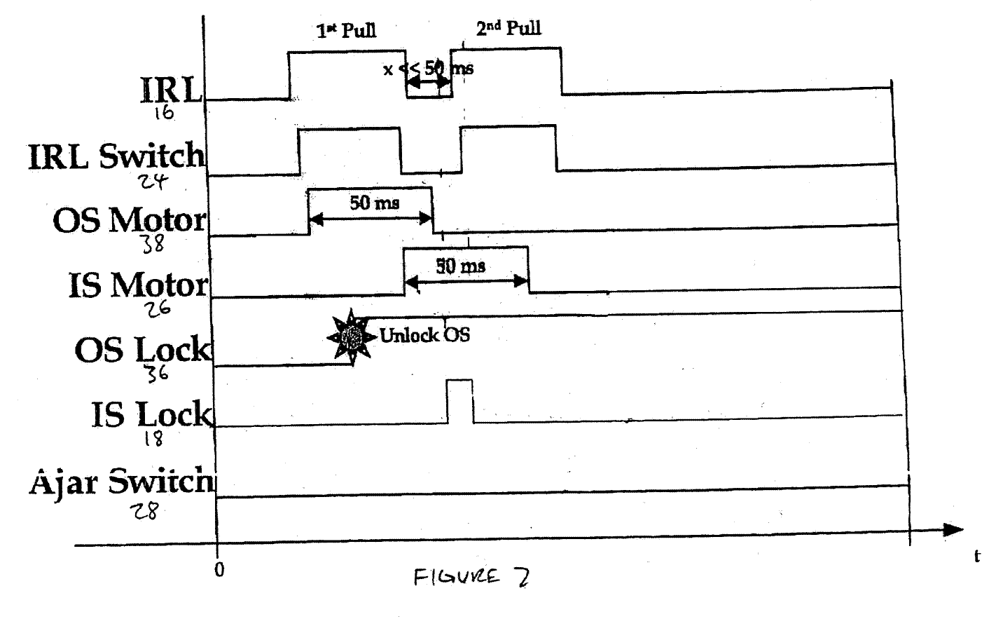

FIG. 7 illustrates operation of a prior art system that does not contain the inventive control system and where the time delay x between the first and second pulls of the inside handle 14 is less than the selected time period (e.g., 50 milliseconds). In this case, the inside motor 26 is driven to unlock the inside lock mechanism 18 as the second pull of inside door handle 14 occurs. However, because of the construction of the latch mechanism in this example, it is not possible for the inside lock 18 to be unlocked while the inside door handle 14 is being pulled. Thus, the unlocking operation of the inside lock 18 fails and the second pull fails to release the latch, as reflected by a continued low output from the door ajar switch 28.

With this type of prior art control system, an additional, third pull on the inside door handle 14 would be required to complete unlocking, with a fourth pull then being required to release the latch 12. Clearly, this represents an inconvenience to a vehicle user.

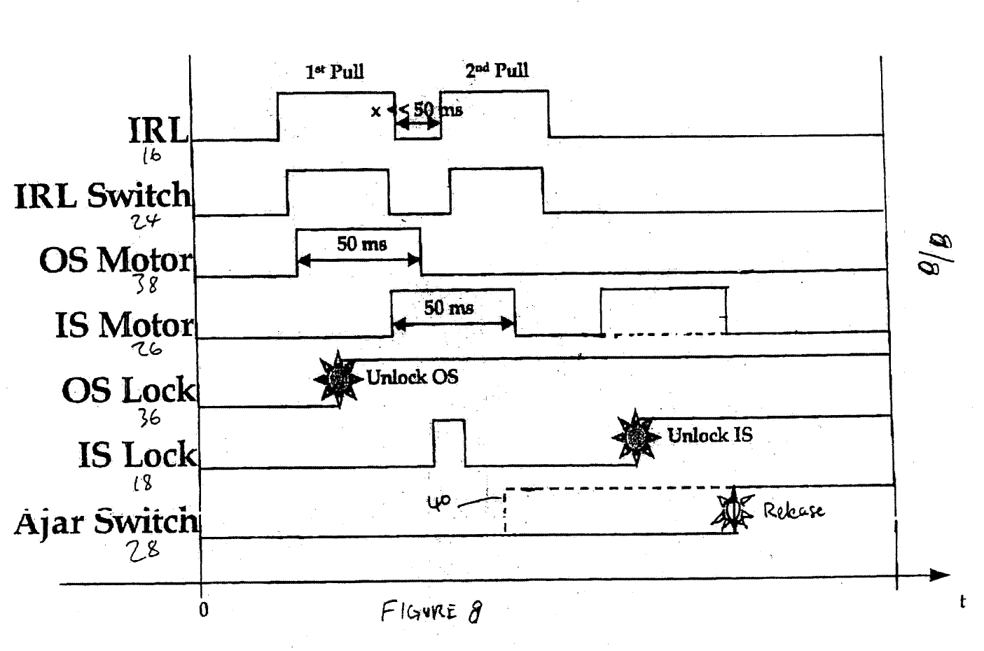

FIG. 8 illustrates a similar situation as FIG. 7 except that the inventive control system is used to control operation of the latch 12. Like the example shown in FIG. 7, FIG. 8 shows an operation where the time delay x is less than the selected time period, meaning that unlocking of the inside lock mechanism 18 fails. However, the controller 30 in this case is programmed to expect receipt of an output from the door ajar switch 28 shortly after the second pull (as represented by broken line 40). If the controller 30 does not receive this signal, the logic of controller 30 recognizes this as an unlocking malfunction. The controller 30 then signals the inside motor 26 a second time to unlock the inside lock 18 before signalling the power release actuator 32 (not shown in FIG. 8) to release the claw 22, thereby causing the door ajar switch 28 to emit a high output. Alternatively, in latches not having power release capabilities, the inside handle 14 may be pulled a third time to release the claw 22 manually.

Because the invention is constructed as a closed loop system that monitors the inside release lever switch 24 and door ajar switch 28, it is possible to maintain proper functioning of the latch 12 even if a vehicle user provides an input that falls outside of the normal double-pull operating parameters of the latch 12.

In another embodiment, the controller 30 determines that an instruction from a vehicle user will cause a malfunction in a latch 12 before instructing the latch 12 to execute the instruction (e.g., because it has stored the time delay an actuator requires to perform a certain function). In this case, the controller 30 is programmed to delay one or more steps in a sequence of instructions to prevent the anticipated malfunction from occurring.

It will be appreciated by those skilled in the art that the principle of closed loop control may be applied to other latch operating functions. A typical latch 12 may include or be associated with switches in addition to the inside release switch 24 and door ajar switch 28, such as a lock status indicator switch, central door locking switch, superlock switch, release switch, closure switch interior light (often fitted to the striker or hinge face of the door), child safety switch, as well as two switches per motor that are triggered at the extremes of the motor's drive. Additionally, latches may be fitted with the additional actuators, such as actuators controlling superlocking, closure and child safety. Any or all of these switches and actuators may be incorporated into and controlled by the inventive control system without departing from the scope of the invention.

By monitoring the status of these various switches and by providing the appropriate logic within the controller to interpret the latch operation from the switches, the inventive closed loop control system is capable of performing vehicle security functions, vehicle safety functions, latch diagnostic functions, and vehicle comfort functions as well as determining when state changes of various latch components should be conducted by one or more of the actuators described above. The present invention also relates to a method of controlling a latch using a closed loop control system. It should be noted that although the system has been described in relation to the control of a single latch, it may be employed in relation to more than one latch on the same vehicle.

It should be understood that various alternatives to the embodiments of the invention described herein may be employed in practicing the invention. It is intended that the following claims define the scope of the invention and that the method and apparatus within the scope of these claims and their equivalents be covered thereby.

1. A control system for a vehicle door latch having a claw that releasably retains a latch bolt, the control system comprising:
a first sensor that generates an output corresponding to a door release lever operation;
a second sensor that generates an output corresponding to release of the claw from a fully latched position; and
a controller coupled to the latch and the release actuator to form a closed loop, wherein the controller monitors the outputs of at least one of the first and second sensors to detect a latch malfunction.

2. The control system of claim 1, further comprising a release actuator controlled by the controller and operably coupled to the claw to release the claw from the fully latched position.

3. The control system of claim 1, wherein the controller detects a latch malfunction based on the outputs of both the first and second sensors.

4. The control system of claim 1, wherein the first sensor is an inside release lever switch that indicates operation of an inside door release lever and the second sensor is a door ajar switch.

5. The control system of claim 4, wherein the door ajar switch is triggered when the claw is in between a fully latched abutment and a first safety abutment of a pawl operably coupled to the claw.

6. The control system of claim 1, wherein the latch further comprises:
a locking mechanism movable between a locked and an unlocked state; and
a locking actuator operable by the controller to move the locking mechanism between the locked and unlocked state.

7. The control system of claim 6, wherein the controller instructs the locking actuator to delay movement of the locking mechanism to the unlocked state until after the claw releases from the fully latched position.

8. The control system of claim 6, further comprising an intermediate release lever disposed between the locking mechanism and the locking actuator, wherein the first sensor reflects a state of the intermediate release lever based on the door release lever operation.

9. The control system of claim 1, wherein the controller comprises a timer, and wherein the controller indicates the latch malfunction if the first sensor output remains at a selected level for a predetermined time period set by the timer.

10. The control system of claim 1, wherein the controller detects a first door handle operation and a second door handle operation, wherein the controller instructs the actuator to release the claw if it does not detect the second sensor output after the second operation.

11. The control system of claim 1, wherein the first sensor and the second sensor are selected from the group consisting of an inside release sensor, an outside release sensor, a door ajar sensor, lock status indicator sensor, a central door locking sensor, a superlock sensor, a release sensor, a door closure sensor, a child safety sensor, and an extreme motor operation sensor.

12. The control system of claim 1, further comprising an additional actuator selected from the group consisting of a superlocking actuator, a door closure actuator, and a child safety actuator.

13. A control system for a vehicle door latch, comprising: a latch having
a release lever switch having a state corresponding to a door release lever operation,
a locking mechanism movable between a locked and an unlocked state,
a locking actuator operable to move the locking mechanism between the locked and unlocked state,
a pawl operably coupled to the locking mechanism and the outside locking mechanism,
a claw that releasably retains a latch bolt and is operably coupled to the pawl, and
a door ajar switch that generates an output corresponding to release of the claw from a fully latched position;
a release actuator operably coupled to the pawl to lift the pawl to release the claw from the fully latched position; and
a controller coupled to the latch and the release actuator to form a closed loop, wherein the controller monitors the outputs of the release lever switch and the door ajar switch to detect an operating state of the latch and control operation of the release actuator.

14. The control system of claim 13, wherein the door ajar switch is triggered when the claw is in between a fully latched abutment and a first safety abutment of the pawl.

15. The control system of claim 13, wherein the controller instructs the locking actuator to delay movement of the locking mechanism to the unlocked state until after the claw releases the latch bolt.

16. The control system of claim 13, further comprising an intermediate release lever disposed between the locking mechanism and the locking actuator, wherein the first sensor reflects a state of the intermediate release lever based on the door release lever operation.

17. The control system of claim 13, wherein the controller comprises a timer, and wherein the controller indicates the latch malfunction if the first switch output remains at a selected level for a predetermined time period set by the timer.

18. The control system of claim 13, wherein the controller detects a first door release lever operation and a second door release lever operation, wherein the controller instructs the release actuator to release the claw if it does not detect the second sensor output after the second door release lever operation.

19. The control system of claim 13, wherein the locking mechanism is a first locking mechanism and the locking actuator is a first locking actuator, and where the latch further comprises:
a second locking mechanism movable between a locked and an unlocked state,
a second locking actuator operable by the controller to move the second locking mechanism between the locked and unlocked state.

20. The control system of claim 19, wherein the controller includes a two-pull override unlocking function logic that signals the first and second locking actuators to unlock the first and second locking mechanisms, respectively, after a first door release lever operation and instructs the release actuator to lift the pawl after a second door release lever operation.

21. The control system of claim 19, wherein the controller includes a single-pull override unlocking function logic that triggers the first release switch, signals the second locking actuator to unlock the second locking mechanism, signals the release actuator to lift the pawl, and signals the first locking mechanism to unlock after the door ajar switch triggers when the pawl releases the claw from the fully latched position.

22. A method of controlling a vehicle door latch having a claw that releasably retains a latch bolt during a fully latched position, the control system comprising:
monitoring a first sensor corresponding to an operation state of a door release lever;
monitoring a second sensor corresponding to release of the claw from a fully latched position;
interpreting the first and second operating states to detect a latch malfunction; and
controlling a release actuator that releases the claw from the fully latched position based on the interpreting step.

23. The method of claim 22, wherein the interpreting step detects a latch malfunction when the second sensor indicates release of the claw from the fully latched position at the same time the first sensor indicates actuation of the door release lever.

24. The method of claim 23, further comprising:
disconnecting power to the release actuator if the latch malfunction is detected.

25. The method of claim 22, wherein the interpreting step indicates a latch malfunction if the first sensor remains at a selected operating state for a predetermined time period.

26. The method of claim 22, further comprising:
detecting a first door release lever operation;
releasing the claw from the fully latched position; and
signalling a locking actuator to unlock a locking mechanism after the second sensor indicates release of the claw from the fully latched position.

27. The method of claim 26, further comprising:
signalling a second locking actuator to unlock a second locking mechanism at the same time the claw is released from the fully latched position.

28. The method of claim 22, further comprising:
detecting a first door release lever operation;
signalling at least one locking actuator to unlock at least one locking mechanism after detecting the first door release lever operation;
detecting a second door release lever operation; and
instructing the release actuator to release the claw from the fully latched position after detecting the second door release lever operation.

29. The method of claim 28, further comprising repeating the signalling step and the instructing step if the second sensor does not indicate release of the claw from the fully latched position after detecting the second door release lever operation.
